(19) United States
(12) Patent Application Publication
(10) Pub. No.: US 2016/0051906 A1
(43) Pub. Date: Feb. 25, 2016

(54) VALVE FOR EXTRACTING AIR POCKETS FROM VISCOUS FLUIDS

(71) Applicant: The Boeing Company, Chicago, IL (US)

(72) Inventor: David Michael Dembeck, Renton, WA (US)

(21) Appl. No.: 14/466,380

(22) Filed: Aug. 22, 2014

(51) Int. Cl. B01D 19/00; F16K 24/04

(52) U.S. Cl. CPC B01D 19/0063; F16K 24/04

(57) ABSTRACT

A valve for extracting an air pocket from a continuous flow of viscous fluid is disclosed. The valve has a first position and a second position. The valve may include an inlet, an outlet, an outer body, and inner body located within the outer body. The inner body may define a chamber and a venting aperture. The valve may also include a plunger translatable within the chamber of the inner body between the first position and the second position. The plunger may include a plunger head located at a first end of the plunger, where the plunger is in the first position if the viscous fluid impinges against the plunger head. The plunger may include at least one opening located adjacent the plunger head. The plunger may also include a passageway fluidly connected with the at least one opening and the venting aperture.

### FIELD

The disclosed system and method relates to a valve for extracting air pockets from a continuous flow of viscous fluid and, more particularly, to a valve having a plunger that translates from a first position and into a second position if an air pocket comes into contact with a plunger head.

### BACKGROUND

Viscous fluids such as, for example, sealing materials, caulking agents or adhesives may be dispensed from a nozzle and applied to a component. One example of such an application is when a sealing material is applied to a fuel tank. However, sometimes relatively large air pockets or bubbles may become entrained within the viscous fluid before being dispensed from the nozzle and onto the component. When the air pocket is expelled from the nozzle, this creates an uneven in-line flow. In other words, the air pocket may cause the viscous fluid to splatter or spray uncontrollably from the nozzle and onto the component. Various types of valves such as poppet valves are currently available and may be used to remove air pockets from a viscous fluid. However, there is a continuing need in the art for an improved mechanism for removing air pockets from a fluid.

### SUMMARY

In one aspect, a valve for extracting an air pocket from a continuous flow of viscous fluid is disclosed. The valve has a first position and a second position. The valve may include an inlet, an outlet, an outer body, and inner body located within the outer body. The inner body may define a chamber and a venting aperture. The valve may also include a plunger translatable within the chamber of the inner body between the first position and the second position. The plunger may include a plunger head located at a first end of the plunger, where the plunger is in the first position if the viscous fluid impinges against the plunger head. The plunger may include at least one opening located adjacent the plunger head. The plunger may also include a passageway fluidly connected with the at least one opening and the venting aperture. The plunger is configured to translate within the chamber of the inner body from the first position into the second position if the air pocket impinges against the plunger head.

In another aspect, a method of extracting an air pocket from a continuous flow of viscous fluid by a valve having an open position and a second position is disclosed. The method includes allowing the viscous fluid to enter the valve through an inlet of the valve. The valve may include an outer body, and inner body located within the outer body, and a plunger translatable within a chamber of the inner body. The method also includes impinging the viscous fluid against a plunger head to urge the plunger within the inner body into the first position. The plunger head may be located at a first end of the plunger. The method also includes translating the plunger from the first position and into the second position based on the air pocket impinging against the plunger head. Finally, the method includes allowing air within the air pocket to travel through at least one opening located adjacent the plunger head within the plunger, through a passageway fluidly connected with the at least one opening, and through a venting aperture located within the inner body.

Other objects and advantages of the disclosed method and system will be apparent from the following description, the accompanying drawings and the appended claims.

### BRIEF DESCRIPTION OF THE DRAWINGS

FIG. 1 is a schematic illustration of the disclosed valve for extracting air pockets from a flow of viscous fluid;

FIG. 2 is a partially cross-sectioned illustration of another embodiment of the valve shown in FIG. 1, where the valve is in a second position and the interior components of the valve are visible;

FIG. 3 is an illustration of the valve shown in FIG. 2 in a first position;

FIG. 4 is a perspective view of the valve shown in FIG. 1; and

FIG. 5 is an enlarged view of a plunger head shown in FIG. 4.

### DETAILED DESCRIPTION

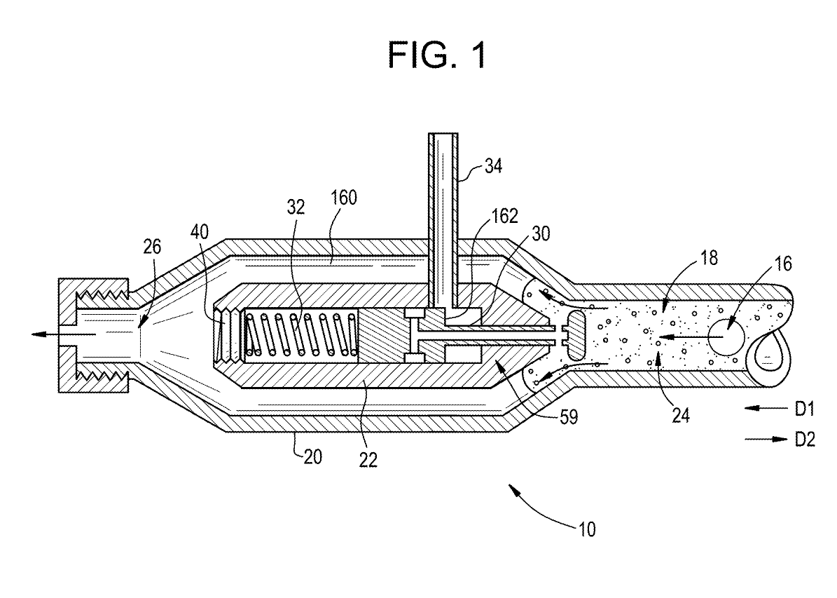

FIG. 1 illustrates the disclosed valve 10 according to an aspect of the disclosure. The valve 10 may be used to extract one or more gas or air pockets 16 that are entrained within a viscous fluid 18. The viscous fluid 18 may be any type of fluid having a viscosity at least as high as water at 20° C. (1.0020 millipascal seconds). For example, in one approach the viscous fluid 18 may be adhesive, sealant, molten plastic, plaster, wax, or sludge. In another approach the viscous fluid 18 may be a food product such as, for example, peanut butter, butter, or a soft candy such as caramel. The air pocket 16 may contain air or gas having a density less than the density of the viscous fluid 18. The valve 10 may include an outer body 20, an inner body 22 located within the outer body 20, an inlet 24, an outlet 26, a plunger 30, a biasing element 32, a vent tube 34, and a retaining element 40.

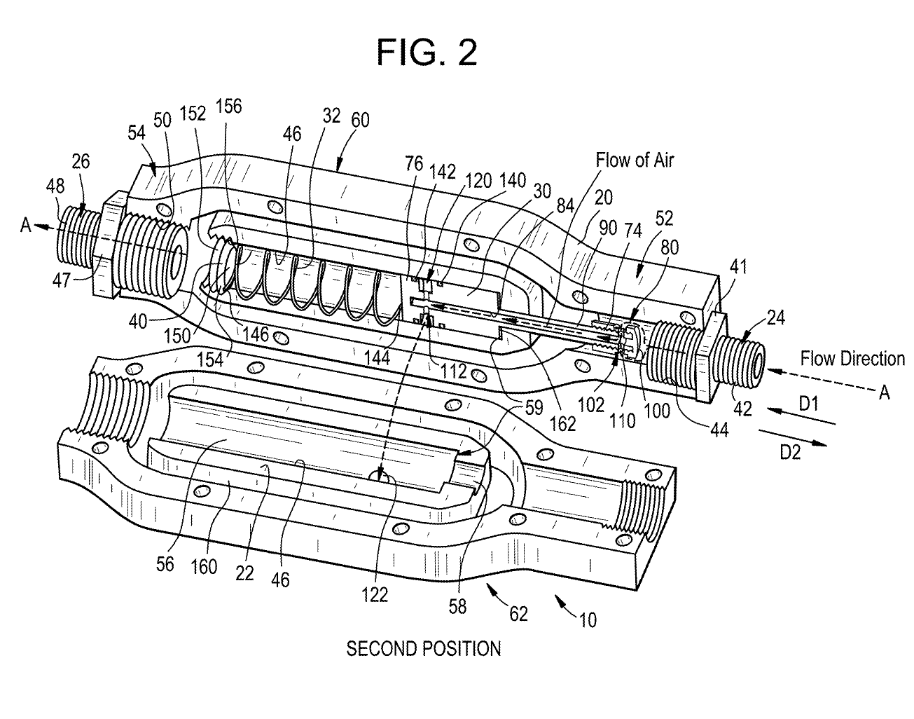

In one embodiment the valve 10 may be used to apply the viscous fluid 18 to an object. For example, if the viscous fluid 18 is a sealant, then the sealant may enter the valve 10 through the inlet 24 and exit the valve 10 at the outlet 26. The sealant may be applied to an object such as, for example, a fuel tank. FIG. 2 is another embodiment of the valve 10, where both the inlet 24 and the outlet 26 of the valve 10 includes fittings that are threadingly engaged with the outer body 20. Specifically, an inlet fitting 41 may include a series of outer threads 42. The outer threads 42 may threadingly engage with a series of inner threads 44 located along an inner surface 46 of the outer body 20 at the inlet 24. Similarly, an outlet fitting 47 may also include a series of outer threads 48. The outer threads 48 may threadingly engage with a series of inner threads 50 located along the inner surface 46 of the outer body 20 at the outlet 26. It is to be understood in one approach that the inlet fitting 41 as well as the outlet fitting 47 may be purchased items that are assembled to the valve 10.

In the example as illustrated, the outer body 20 may include a generally cylindrical profile as well as a first end 52 and a second end 54. The first end 52 and the second end 54 of the outer body 20 may be tapered. The inner body 22 of the valve 10 may define a first generally cylindrical profile 56 and a second generally cylindrical profile 58, where the first generally cylindrical profile 56 may have a diameter greater than the second generally cylindrical profile 56. The inner body 22 may also define a shoulder 59 located between the first generally cylindrical profile 56 and the second generally cylindrical profile 58. In the non-limiting example as shown in FIG. 2, the outer body 20 and the inner body 22 may both be defined by a two-part housing split along a longitudinal axis A-A of the valve 10. Specifically, a first housing 60 and a second housing 62 may be joined together along the axis A-A of the valve. Alternatively, in another approach the outer body 20 and the inner body 22 may both be solid, unitary parts.

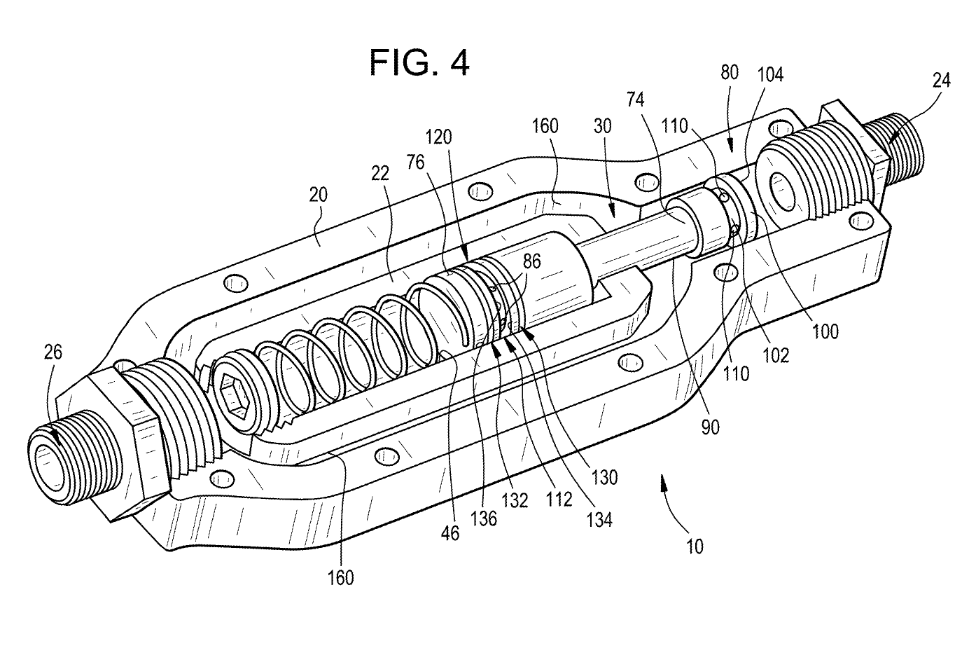

Referring to both FIGS. 2 and 4, the plunger 30 may include a first end 74 (seen in FIG. 2) and a second end 76. The plunger 30 may also include a plunger head portion 80 threadingly engaged with the first end 74 of the plunger 30, where the threading engagement is seen in FIG. 2. Specifically, the plunger head portion 80 may be a separate component from the plunger 30, where the plunger head portion 80 may be threadingly engaged with an outer surface 90 of the plunger 30. The plunger 30 may also define a passageway 84 extending along the longitudinal axis A-A of the valve 10 (seen in FIG. 2) as well as one or more openings 86 located adjacent the second end 76 of the plunger 30 (seen in FIG. 4).

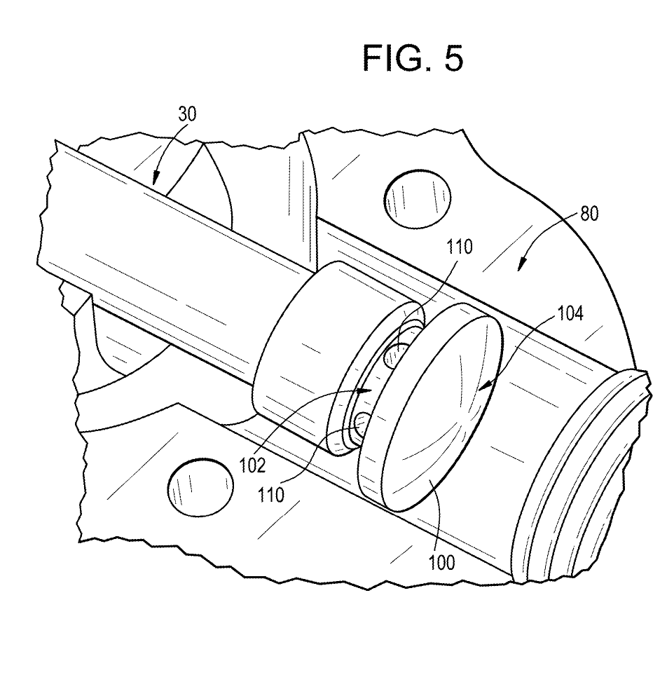

Continuing to refer to both FIGS. 2 and 4, the plunger head portion 80 may define a head 100 as well as an annular recess 102. In one non-limiting embodiment, the head 100 may include a substantially mushroom-shaped or dome-shaped outer profile 104 (seen in FIG. 5). Those skilled in the art will readily appreciate that the head 100 of the plunger 80 may include other shapes or profiles as well. One or more openings 110 (seen in FIG. 4) may be positioned within the annular recess 102 of the plunger head portion 80. Specifically, the annular recess 102 and the openings 110 may be located adjacent or proximate the plunger head 100. The openings 110 may be fluidly connected with the passageway 84 of the plunger 30 (seen in FIG. 2). The openings 86 located adjacent the second end 76 of the plunger 30 may be positioned within an annular recess 112 defined by the plunger 30. The openings 86 may also be fluidly connected with the passageway 84 of the plunger 30 (seen in FIG. 2). Moreover, the annular recess 112 defined by the plunger 30 may also cooperate with the inner surface 46 of the inner body 22 in order to define a chamber 120. As seen in FIG. 2, the chamber 120 may be fluidly connected with a venting aperture 122 defined along the inner surface 46 of the inner body 22. The venting aperture 122 may be fluidly connected with the vent tube 34 shown in FIG. 1. In one embodiment, the vent tube 34 may release air or gas into the atmosphere.

Referring to FIG. 4, in one embodiment, the plunger 30 may also include two annular recesses 130, 132. Specifically, a lower annular recess 130 may be disposed adjacent a bottom side 134 of the annular recess 112, and an upper annular recess 132 may be disposed along an upper side 136 of the annular recess 112. As seen in FIG. 2, respective O-rings 140, 142 may be disposed within the lower annular recess 130 and the upper annular recess 132. The O-rings 140, 142 may be used to provide a generally fluid-tight seal to the annular recess 112 such that the viscous fluid 24 (shown in FIG. 1) may not substantially enter the chamber 120.

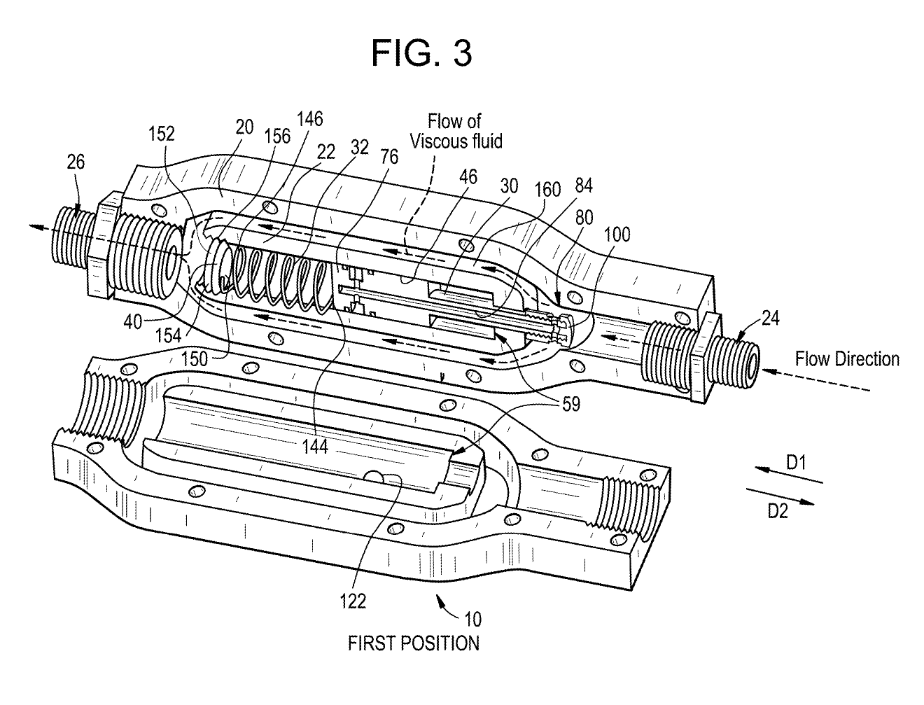

Referring to FIGS. 1-3, the plunger 30 may translate back and forth within the inner body 22 between a first position (shown in FIG. 3) and a second position (shown in FIG. 2). When the plunger 30 is in the first position, the viscous fluid 18 may impinge against the plunger head 80, thereby exerting a force against the head 100 of the plunger 30. The force exerted upon the head 100 of the plunger 30 may urge the plunger 30 to translate in a first direction D1, towards the outlet 26 of the valve 10. As described in greater detail below, the force exerted by the viscous fluid 18 upon the head 100 of the plunger 30 may be sufficient to normally position the plunger 30 in the first position during operation of the valve 10. However, if the air pocket 16 entrained within the viscous fluid 18 approaches and makes contact with the head 100 of the plunger 30, then the plunger 30 may translate within the inner body 22 in a second direction D2, towards the inlet 24 of the valve 10 and into the second position as seen in FIG. 2. Those skilled in the art will readily appreciate that if the valve 10 is not operating, and if viscous fluid is not flowing through the valve 10, then the plunger 30 may be normally positioned in the second position.

Continuing to refer to FIGS. 1-3, the biasing element 32 may include a first end 144 and a second end 146. The first end 144 of the biasing element 32 may abut against the second end 76 of the plunger 30, and the second end 146 of the biasing element 32 may abut against an end surface 150 of the retaining element 40. The biasing element 32 may be configured to exert a biasing force against the second end 76 of the plunger 30 in the second direction D2, towards the inlet 24 of the valve 10. In the non-limiting example as illustrated in the figures, the biasing element 32 is a coil spring. However, those skilled in the art will readily appreciate that any other type of biasing element configured to exert the biasing force against the second end 76 of the plunger 30 may be used as well. Moreover, in an alternative approach the biasing element 32 may be replaced with a pressurized air or gas cylinder. Specifically, the first generally cylindrical profile 56 of the inner body 22 may be fluidly connected to a source of pressurized air or gas (not illustrated). The pressured air or gas may exert a force against the second end 76 of the plunger 30 in the second direction D2, towards the inlet 24 of the valve 10.

Referring to FIGS. 2 and 3, the retaining element 40 may be threadingly engaged with the inner surface 46 of the inner body 22. Specifically, an outer surface 152 of the retaining element 40 may include a plurality of threads 154 that threadingly engage with a plurality of threads 156 located along an the inner surface 46 of the inner body 22. The position of the retaining element 40 relative to the second end 76 of the plunger 30 may be adjustable. Specifically, the retaining element 40 may be rotatable about the threads 156 along the inner surface 46 of the inner body 22. For example, in one approach the retaining element 40 may be rotated about the threads 156 of the inner body 22 in a first rotational direction, thereby translating the retaining element 40 in the first direction D1 and away from the second end 76 of the plunger 30. Alternatively, the retaining element 40 may be rotated about the threads 156 of the inner body 22 in a second rotational direction, thereby translating the retaining element 40 in the second direction D2 and towards the second end 76 of the plunger 30.

The position of the retaining element 40 relative to the second end 76 of the plunger 30 may be adjusted in order to either increase or decrease the biasing force exerted by the biasing element 32. Specifically, the biasing force exerted by the biasing element 32 against the plunger 30 may be increased by translating the retaining element 40 towards the second end 76 of the plunger 30. Similarly, the biasing force exerted by the biasing element 32 may be decreased by translating the retaining element 40 away from the second end 76 of the plunger 30. The biasing force exerted by the biasing element 32 may be adjusted based on the viscosity of the specific type of viscous fluid 18 (seen in FIG. 1).

Referring to FIGS. 1, 3, and 5, if the valve 10 is in the first position the viscous fluid 18 may enter the valve 10 through the inlet 24. The viscous fluid 18 may then impinge against the head 100 of the plunger 30, flow through a passageway 160 formed between the outer body 20 and the inner body 22, and then exit the valve 10 through the outlet 26. The force created by the viscous fluid 18 impinging against the head 100 of the plunger 30 in the first direction Dl may be greater than the biasing force exerted by the biasing element 32 against the second end 76 of the plunger 30 in the second direction D2. Thus, as the viscous fluid 18 flows through the valve 10, the force exerted by the viscous fluid 18 upon the head 100 of the plunger 30 may be sufficient to retain the plunger 30 in the first position.

Referring to FIGS. 1-2 and 5, if one or more air pockets 16 (seen in FIG. 1) approach and make contact with the head of the plunger 30, then the plunger 30 may translate in the second direction D2 and into the second position (seen in FIG. 2). This is because the density of the air or gas trapped within the air pocket 16 is less than the density of the viscous fluid 18. Thus, the air pocket 16 may generally be unable to exert a force in the first direction D1 sufficient to overcome the biasing force exerted by the biasing element 32 in the second direction D2. As a result, the biasing element 32 urges the plunger 30 in the second direction D2 and into the second position as seen in FIG. 2. Specifically, the plunger 30 may translate within the inner body 22 of the valve 10 in the second direction D2, until a surface 162 of the plunger 30 abuts against the shoulder 59 defined by the inner body 22.

When the plunger 30 is in the second position, the air or gas trapped within the air pocket 16 may be vented through the venting aperture 122 defined along the inner surface 46 of the inner body 22. Specifically, referring to both FIGS. 2 and 5, the gas trapped within the air pocket 16 may first flow around the substantially dome-shaped outer profile 104 (seen in FIG. 5) of the plunger head 100. The gas may then flow through the openings 110 within the annular recess 102 of the plunger head portion 80, through the passageway 84 of the plunger 30, and to the chamber 120. The gas may then flow from the chamber 120, through the venting aperture 122 and into the vent tube 34 shown in FIG. 1. The gas may then escape to the atmosphere.

The plunger 30 may remain in the second position until the air pocket 16 is substantially dissipated. Once the air pocket 16 is substantially dissipated, the force created by the viscous fluid 18 impinging against the head 100 of the plunger 30 may overcome the biasing force exerted by the biasing element 32. The plunger 30 may then translate within the inner body 22 of the valve 10 in the first direction D1, and back into the normally first position as seen in FIG. 3.

Referring generally to the figures, the disclosed valve 10 may be an in-line device used to extract one or more air pockets 16 entrained within a viscous fluid 18. Specifically, the plunger 30 may be generally aligned with the flow of the viscous fluid 18, thereby providing an in-line solution for substantially de-aerating a viscous fluid. Moreover, the disclosed valve 10 may also be easier to clean when compared to some other types of known devices that are currently available for de-aerating a viscous fluid.

While the forms of apparatus and methods herein described constitute preferred aspects of this disclosure, it is to be understood that the disclosure is not limited to these precise forms of apparatus and methods, and the changes may be made therein without departing from the scope of the disclosure.

What is claimed is:

1. A valve for extracting an air pocket from a continuous flow of viscous fluid, the valve having a first position and a second position, the valve comprising:
an inlet, an outlet, an outer body, and inner body located within the outer body, the inner body defining a chamber and a venting aperture; and
a plunger translatable within the chamber of the inner body between the first position and the second position, the plunger including:
a plunger head located at a first end of the plunger, wherein the plunger is in the first position if the viscous fluid impinges against the plunger head;
at least one opening located adjacent the plunger head; and
a passageway fluidly connected with the at least one opening and the venting aperture, wherein the plunger is configured to translate within the chamber of the inner body from the first position into the second position if the air pocket contacts the plunger head.

2. The valve of claim 1, comprising a biasing element located within the inner body, the biasing element configured to exert a biasing force against a second end of the plunger.

3. The valve of claim 2, wherein the biasing force exerted by the biasing element is configured to urge the plunger into the second position if the air pocket contacts the plunger head.

4. The valve of claim 2, comprising a retaining element retaining element threadingly engaged with an inner surface of the inner body.

5. The valve of claim 4, wherein the biasing element includes a first end and a second end, and wherein the first end of the biasing element abuts against the second end of the plunger and the second end of the biasing element abuts against an end of the retaining element.

6. The valve of claim 4, wherein a position of the retaining element relative to the second end of the plunger is adjustable in order to either increase the biasing force exerted by the biasing element or decrease the biasing force exerted by the biasing element.

7. The valve of claim 2, wherein the biasing element is a coil spring.

8. The valve of claim 1, wherein a second end of the plunger includes a recess and a plurality of second openings located within the recess, and wherein the plurality of second openings are fluidly connected the passageway of the plunger.

9. The valve of claim 1, wherein the plunger head includes a substantially dome-shaped outer profile.

10. The valve of claim 1, wherein the plunger is configured to translate within the inner body in a first direction towards the outlet of the valve and in a second direction towards the inlet of the valve.

11. The valve of claim 1, wherein the viscous fluid is selected from the group consisting of: adhesive, sealant, molten plastic, plaster, wax, sludge, peanut butter, butter, a soft candy, and caramel.

12. The valve of claim 1, wherein the viscous fluid includes a viscosity that is at least about 1.0020 millipascal seconds.

13. A method of extracting an air pocket from a continuous flow of viscous fluid by a valve having a first position and a second position, the method comprising:
allowing the viscous fluid to enter the valve through an inlet, wherein the valve includes the inlet, an outer body, and inner body located within the outer body, and a plunger translatable within a chamber of the inner body;
impinging the viscous fluid against a plunger head to urge the plunger within the inner body into the first position, wherein the plunger head is located at a first end of the plunger;
translating the plunger from the first position and into the second position based on the air pocket contacting the plunger head; and
allowing air within the air pocket to travel through at least one opening located adjacent the plunger head within the plunger, through a passageway fluidly connected with the at least one opening, and through a venting aperture located within the inner body.

14. The method of claim 13, comprising translating the plunger from the second position and back into the first position based on the air pocket being substantially dissipated.

15. The method of claim 13, comprising a biasing element located within the inner body, the biasing element configured to exert a biasing force against a second end of the plunger.

16. The valve of claim 15, comprising urging the plunger into the second position by the biasing force exerted by the biasing element if the air pocket contacts the plunger head.

17. The valve of claim 13, comprising threadingly engaging a retaining element with an inner surface of the inner body.

18. The valve of claim 13, comprising translating the plunger in a first direction within the inner body and towards an outlet of the valve in order to position the plunger in the first position.

19. The valve of claim 13, comprising translating the plunger in a second direction within the inner body and towards the inlet of the valve in order to position the plunger in the second position.

20. The valve of claim 13, wherein the viscous fluid is selected from the group consisting of: adhesive, sealant, molten plastic, plaster, wax, sludge, peanut butter, butter, a soft candy, and caramel.
